(19) United States
(12) Patent Application Publication
(10) Pub. No.: US 2016/0188169 A1
(43) Pub. Date: Jun. 30, 2016

(54) LEAST TOUCH MOBILE DEVICE

(71) Applicant: TCL RESEARCH AMERICA INC., San Jose, CA (US)

(72) Inventor: HAOHONG WANG, San Jose, CA (US)

(73) Assignee: TCL RESEARCH AMERICA INC.

(21) Appl. No.: 14/587,458

(22) Filed: Dec. 31, 2014

(51) Int. Cl. G06F 3/0484; H04W 4/00; G06F 17/30; H04W 4/18

(52) U.S. Cl. CPC G06F 3/04842; H04W 4/18; H04W 4/003; G06F 3/04847; G06F 17/30528

(57) ABSTRACT

A method for personalized direct app transition on a mobile device is provided. The method includes receiving behavior statistics data of a user of the mobile device and analyzing behavior pattern and preference of the user based on the received behavior statistics data. The method also includes determining at least one mobile app recommendation and access point including at least an entrance to the function and a type of the function (FUNC) based on the behavior pattern and preference of the user on the mobile device, where the at least one FUNC includes at least a second app different from the first app and recommending the at least one FUNC to the user. Further, the method includes receiving a selection of the second app by the user from the recommended FUNC and directly transitioning from a first app page to a second app page without returning to any home screen.

### FIELD OF THE INVENTION

The present invention generally relates to the field of computer technologies and, more particularly, to systems and methods for enhanced mobile application transition.

### BACKGROUND

Nowadays, mobile apps have become major user interaction units on mobile devices, such as phones, tablets, smartwatches or other wearable devices, and people spend more and more time in using the mobile apps. The “mobile app” (also called “app”) is a computer program designed to run on smartphones, tablet computers and other mobile devices. However, the number of mobile apps in usage has been stable at around 26 apps/month during the recent years. Compared to the total number of mobile apps (around 2.5 Million mobile apps in total as of mid-2014), the number of 26 mobile apps is really a very tiny percentage (0.001%), which indicates that people may not have been fully utilized the intelligence of the mobile app services available due to the lack of app discovery capability. On the other hand, even inside the mobile app, sometimes it takes user tremendous efforts to discover a function page that addresses the user's immediate need.

Recently, almost all kinds of mobile devices have a home page with the mobile apps. Assuming a user is quite familiar with his/her mobile apps, a typical pattern is that the user finds one mobile app to solve a current need, and then go back to the home page and start another mobile app to solve the next task, thus this loop goes on and on. However, when the user uses multiple apps to achieve a solution, it may be burdensome for the user to switch to different pages of the apps.

The disclosed systems and methods are directed to solve one or more problems set forth above and other problems.

### BRIEF SUMMARY OF THE DISCLOSURE

One aspect of the present disclosure includes a method for direct app transition on a mobile device. The method includes receiving behavior statistics data of a user of a mobile device when the mobile device is running a first app and analyzing behavior pattern and preference of the user on the mobile device based on the received behavior statistics data of the user. The method also includes determining at least one mobile app recommendation and access point including at least an entrance to the function and a type of the function (FUNC) based on the behavior pattern and preference of the user on the mobile device, where the at least one FUNC includes at least a second app different from the first app and recommending the at least one FUNC to the user. Further, the method includes receiving a selection of the second app by the user from the recommended FUNC and directly transitioning from a first app page to a second app page without returning to any home screen on the mobile device.

Another aspect of the present disclosure includes a system for direct app transition on a mobile device. The system includes a user interface and user interaction module configured to receive a user input associated with a first app, and to receive at least one mobile app recommendation and access point including at least an entrance to a function and a type of the function (FUNC) based on behavior pattern and preference of a user on the mobile device, where the at least one FUNC includes at least a second app different from the first app. The system also includes an app pool configured to store a plurality of recommended mobile apps locally, a FUNC usage module configured to send behavior statistics data of the user of the mobile device to a cloud platform, a user behavior and preference analyzer configured to receive the behavior statistics data of the user of the mobile device when the mobile device is running the first app and analyze the behavior pattern and preference of the user on the mobile device based on the received behavior statistics data of the user and a current scenario detector configured to determine a main page for a current scenario utilizing sensing capability of the mobile device. Further, the system includes a FUNC recommender configured to make initial FUNC recommendation to the user based on analyzed results and the current scenario of the mobile device, a next-step FUNC predictor configured to predict next-step FUNC usage based on the analyzed results and the current scenario of the mobile device, a longer-term FUNC predictor configured to predict the user's potential FUNC usage in a next day and after a certain period of time, and a FUNC controller configured to move the mobile apps between the cloud platform and the mobile device by a dynamic app shuffling mechanism such that the FUNCs to be used are available.

Another aspect of the present disclosure includes a computer readable storage medium storing computer-executable instructions to execute operations for direct app transition on a mobile device. The instructions include receiving behavior statistics data of a user of a mobile device when the mobile device is running a first app and analyzing behavior pattern and preference of the user on the mobile device based on the received behavior statistics data of the user. The instructions also include determining at least one mobile app recommendation and access point including at least an entrance to the function and a type of the function (FUNC) based on the behavior pattern and preference of the user on the mobile device, where the at least one FUNC includes at least a second app different from the first app and recommending the at least one FUNC to the user. Further, the instructions include receiving a selection of the second app by the user from the recommended FUNC and directly transitioning from a first app page to a second app page without returning to any home screen on the mobile device.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates an exemplary environment incorporating certain embodiments of the present invention;

FIG. 2 illustrates an exemplary computing system consistent with the disclosed embodiments;

FIG. 3 illustrates a block diagram of an exemplary system for direct app transition consistent with the disclosed embodiments;

FIG. 4 shows an exemplary process for direct app transition performed by a cloud platform consistent with the disclosed embodiments;

FIG. 5 shows an exemplary process for direct app transition performed by an endpoint consistent with the disclosed embodiments; and

FIG. 6 shows another exemplary process for direct app transition consistent with the disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts.

When a user wants to switch from one mobile app to another mobile app, the transition between mobile apps is slower than the direct transition between two mobile app pages if a bridge between two pages exists. The disclosed methods and systems are directed to such direct transition between two mobile app pages and between other application pages under similar situations.

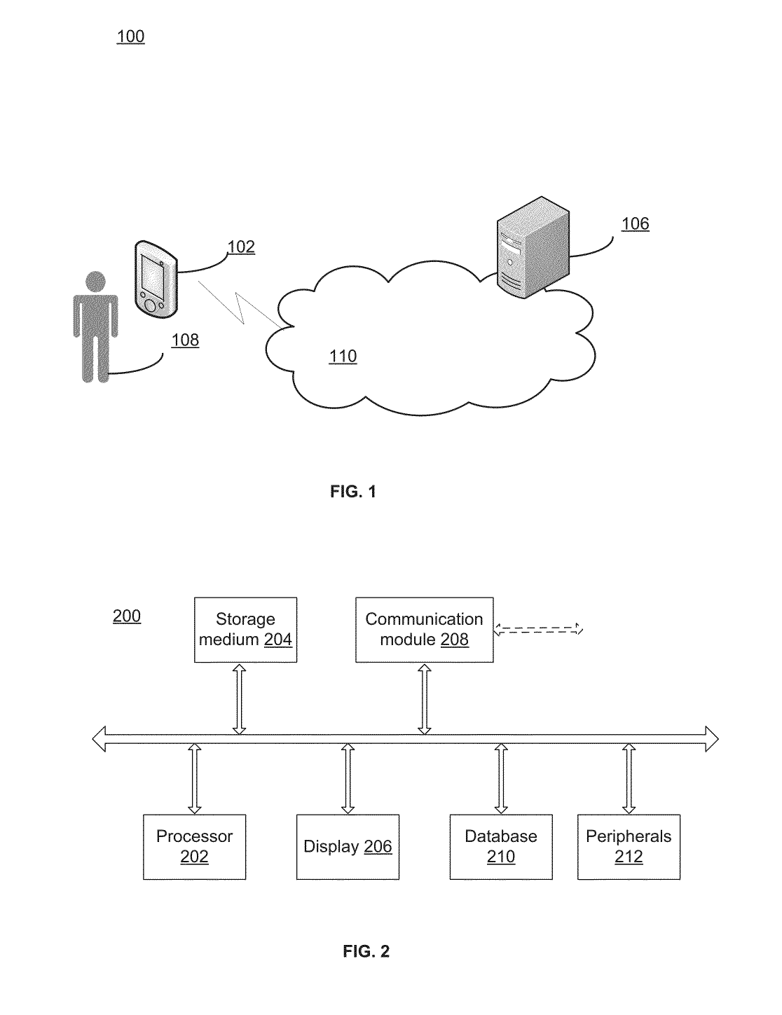

FIG. 1 illustrates an exemplary environment 100 incorporating certain embodiments of the present invention. As shown in FIG. 1, environment 100 may include a mobile device 102, a network device 106, a user 108 and a network 110. Optionally, environment 100 may include an input device (not shown). The input device may include any simple input/output device, such as a keyboard, a mouse, a Touch Pen Stylus and a voice-activated input device, etc.

Mobile device 102 may include any appropriate type of mobile device, such as a tablet or mobile computer, a smart phone, etc. Mobile device 102 may run apps for the user to use. The Mobile device 102 may obtain such apps from any appropriate sources, such as from a local storage device, from a wired or wireless network device of a service provider, or from the Internet. Further, the apps may include any appropriate type of app, such as entertainment app, news app, games app, education app, travel app, social networking app, productivity app, and utilities app, etc.

Further, the network device 106 may include any appropriate type of computing or consumer electronic device to facilitate the communication, data storage, and data processing for mobile device 102. For example, when environment 100 uses an online service, a network device from a service provider may provide apps to mobile device 102, i.e., an app server. Mobile device 102 and network device 106 may communicate with each other through communication network 110, such as a cable network, a phone network, and/or a satellite network, etc. Although one mobile device 102 and one network device/server 106 are shown in FIG. 1, any number of mobile devices and/or network devices may be included.

Mobile device 102, and/or network device 106 may be implemented on any appropriate computing circuitry platform. FIG. 2 shows a block diagram of an exemplary computing system 200 capable of implementing mobile device 102, and/or network device 106.

As shown in FIG. 2, computing system 200 may include a processor 202, a storage medium 204, a display device 206, a communication module 208, a database 210, and peripherals 212. Certain devices may be omitted and other devices may be included.

Processor 202 may include any appropriate processor or processors. Further, processor 202 can include multiple cores for multi-thread or parallel processing. Storage medium 204 may include memory modules, such as ROM, RAM, flash memory modules, and mass storages, such as CD-ROM and hard disk, etc. Storage medium 204 may store computer programs for implementing various processes, when the computer programs are executed by processor 202.

Peripherals 212 may include various sensors and other I/O devices, such as a keypad, a keyboard, and a mouse, and communication module 208 may include certain network interface devices for establishing connections through communication networks. Various devices may include various peripherals 212. For example, the mobile device may include cameras, microphones, and other sensors, etc. Further, database 210 may include one or more databases for storing certain data and for performing certain operations on the stored data, such as database searching.

For example, to access certain app stored on the mobile device 102, the user 108 may first click certain buttons on the mobile device 102, and then use his/her finger(s) to touch the screen of the mobile device 102 to click the app icon. Also, during the period of running the app, the user 108 may click some icons (or some buttons) and/or press some keys on the keyboard to change the app shown on the mobile device 102.

Thus, in operation, the mobile device 102, the network device 106, and/or the input device may perform an automatic process for direct transition between two or more mobile app pages or between other types of apps or functions. That is, instead of returning back to an app launching page or other launching screen after completing a first app, the user can directly access a second app from the first app. To achieve the direct transition, the function(s) of the second app may be first recommended and then accessed directly.

A mobile app recommendation and access point may be used to achieve such direction transition without significant user interactions or involvement. The mobile app recommendation and access point may include an entrance to the function on the mobile device or web, a type of the function, and other relevant information, such as location, status, and nature of the function, etc. The function may include a native mobile app, a web app, a customized function as a cloud application programming interface (API).

A native mobile app may refer to a mobile device application that is coded in a specific programming language for a particular operating system. The native app is installed directly on a mobile device. That is, a native mobile app resides on the mobile device and is accessed through icons on the mobile device home screen. Native apps may be installed through an application store. The native mobile app may often use many device features, such as camera, GPS, accelerometer, compass, list of contacts, and so on, and may also incorporate gestures. Further, a native mobile apps can use the mobile device's notification system and can work offline.

A web app may refer to a website that is tailored to function via a web browser on a mobile device. That is, a web app is not a real application, it is a website having a similar look and feel to a native mobile app, but is not implemented on the mobile device. The user first accesses the web app as the user would access any web page: navigating to a special URL and access the web app, then the user may create a bookmark to the web app page on, for example, the home screen.

The entrance to function and the type of the entrance may include a variety of configurations. For example, the access point may include a link to a web app page, a link to a customized function, a link or shortcut to an installed native app page, a link to a page of a compressed version of a native app, a link to the action of native app download and installation, and a link to an app guideline page that suggests the user to open an alternative app, etc. The status information may indicate whether such function is available locally, over a cloud API, or from a server, etc.

For the sake of convenience, such mobile app recommendation and access point may be represented using the term FUNC. Thus, each FUNC is associated with a function or service that satisfies a user's specific need. For a same need, different users may use different FUNCs in different mobile apps (for example, a user may use Facebook to share a picture, and another user may use WeChat for the same purpose) according to the user's habits or preferences. Because the FUNC provides an entrance to a native app, a web app or a customized function, the FUNC may be used to make transition from one mobile app to the other mobile app, as the FUNC enables the direct access of an app page, which does not require entering the launching page (e.g., the home screen) first and then navigating to a specific app page with multiple user interactions.

With the FUNC, a functional flow of user's action can be built up more smoothly without using the app-level operations. The app-level operations refer to certain operations that are performed among multiple mobile apps or web services by frequently using the home page, and thus more user interactions (screen touches or key presses) may be required. For example, a typical pattern of the app-level operations is that the user can find one mobile app to solve a current need, and then go back to the home page and start another mobile app to solve the next task, thus this loop can go on and on.

On the other hand, a FUNC-level operation (i.e., certain operations of direct transition between two mobile app pages or other similar application pages are performed by the entrance to the function(s) on the mobile device or web) can cross multiple mobile apps or web apps/services. Further, when the user is currently using a FUNC, the disclosed system may predict the next FUNC that the user possibly uses and thus prepares the predicted FUNC in place ahead of time. If the predicted FUNC is not available (i.e., the mobile app has not been installed in local), then an app download operation may be performed to obtain the mobile app in place.

Further, if cost of app downloading is undesired (i.e., cost of app downloading exceeds a threshold set by the user), then an alternative web app replacement may be used as an alternative. The cost may be the time period for downloading the app or amount of money for purchasing and downloading the app. When the user finishes the current FUNC operation, the potential next step(s) can be recommended to the user in the format of FUNCs. The user can select the recommend FUNC to enter the next task.

Data transferring among FUNCs is also supported to improve the user experience. That is, some information used in the previous FUNC can be arranged in place for the current FUNC usage, so that the user does not need to input the information again for the current FUNC. If a user's daily activities correspond to a list of needs and solutions, the corresponding list of FUNCs can be used to replace the solutions that can be resolved via the mobile devices, and the list of sequential FUNCs represents the least user interactions with the mobile devices to accomplish these needs, also called the least-touch mobile application.

Thus, compared to the existing mobile devices, a new user interaction model is provided. That is, the transitions directly between two or more app pages are used. Further, the home page is no longer a stable page (in the existing mobile devices, the home page is generally the first page a visitor navigating to other pages in the mobile apps). The home page can be changed according to the current status detected by sensing modules or user inputs, and the next interaction of the user is predicted to enable the user to access another app's certain page from the current mobile app page.

An average user interaction quantity is used as a user experience factor to evaluate the system. The average user interaction quantity refers to the number of touches or gestures on the mobile device for completing the same task in a certain time period (e.g., 10 minutes). That is, for the same task, the lower the user interaction quantity is, the better the user experience of the mobile device is. In other words, if the user's next immediate need can be predicted by learning the user behavior and preferences and the mobile app page can be prepared to satisfy his/her need, then the user experience can be very smooth, so-called least-touch mobile system. Further, the mobile device cannot install all mobile apps on the mobile device due to storage limitation. Therefore, a virtual app pool is used to swap the mobile apps between the local mobile device and a cloud virtual app pool. On the other hand, scalable app presence concept is also provided to balance between storage limitation and response time of the mobile app. That is, the less component of an app is installed, the slower the response time is, and the smaller the storage allocation on the device is.

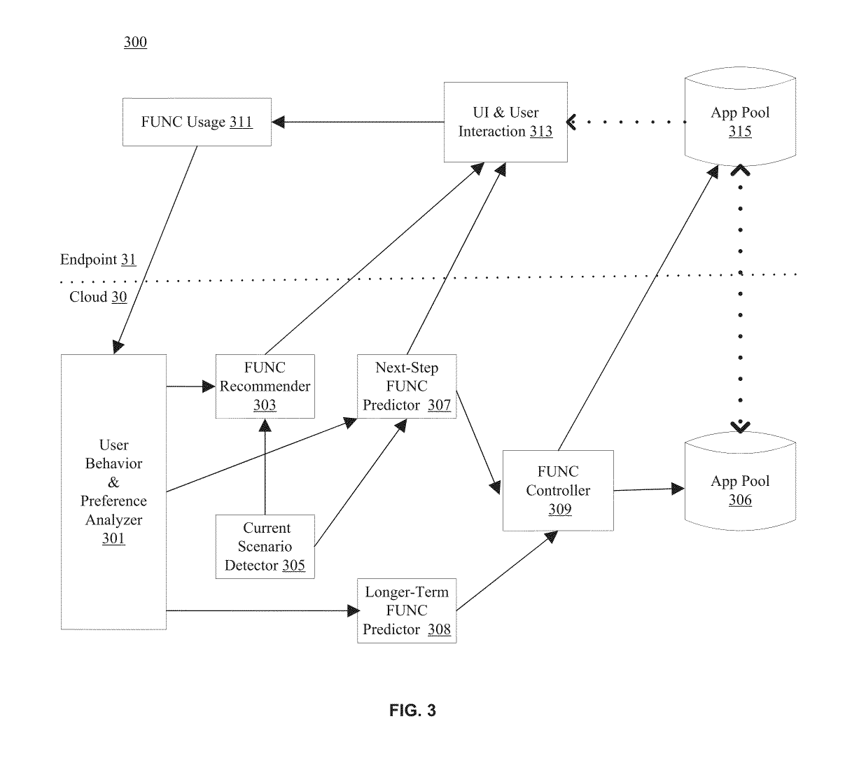

FIG. 3 illustrates a block diagram of an exemplary system for direct app transition consistent with the disclosed embodiments. As shown in FIG. 3, the system 300 is a combination of a cloud platform (also called cloud) 30 and an endpoint 31, where the endpoint 31 can be any kind of mobile device.

The cloud platform 30 (e.g., server 106) may include a user behavior and preference analyzer 301, a FUNC recommender 303, a current scenario detector 305, an app pool 306, a next-step FUNC predictor 307, a longer-term FUNC predictor 308, and a FUNC controller 309. Certain components may be omitted and other components may be added. Various components in the cloud platform 30 may be implemented in hardware, software, or a combination of hardware and software.

The user behavior and preference analyzer 301 may be configured to closely monitor the user's interactions with the mobile device and analyze user access patterns of the user's mobile device usage. An average user interaction quantity may be used as a user experience factor to evaluate the system. The average user interaction quantity refers to the number of touches on the mobile device or gestures for completing the same task in a certain time period (e.g., 10 minutes). For the same task, the lower the user interaction quantity is, the better the user experience of the mobile device is.

The user behavior and preference analyzer 301 may monitor the user's using history within a certain time period and identify a main interest of the user according to the user's using history, such as the user's selection of app categories. Specifically, the user behavior and preference analyzer 301 may monitor the user's interactions, and evaluate the user's behavior pattern. For example, a user may fluently select an app via the buttons on the mobile device.

The user behavior and preference analyzer 301 may analyze the user's mobile device usage from various aspects (e.g., a frequency using a mobile app) in order to determine the relationships between the user's behavior and his/her preferences. For example, the user behavior and preference analyzer 301 may determine the current preference of the user by the click pace of the user interaction and/or the mobile app selected for using.

The user behavior and preference analyzer 301 may also determine the icon (or button) usage pattern or the user's habit in utilizing the icons (or buttons) on the mobile device. For example, some users may click the icons (or buttons) in a fluent manner, while others may only explore limited icons (or buttons) on the mobile device. The men, women, kids, elders may have different taste on the app selection.

The user behavior and preference analyzer 301 may determine the usage model of the app on the mobile device, for example, typical using hours, frequency, and so on. Different people may have different icon (or button) usage patterns, which include the frequency of certain icon (or button) usage, the frequency of certain icon (or button) transferring, and so on. For example, the user behavior and preference analyzer 301 may maintain probability tables for the usage patterns and use the probability tables in identifying the user and the user's behavior model.

More specifically, the user behavior is analyzed from many angles, such as certain menu/key/button usage, and certain gesture usage, in order to capture internal connections between the user's behavior and his/her preferences. To better understand the user access patterns in the system, the distribution of user accesses can be characterized as a function of time. For example, the user behavior and preference analyzer 301 may examine the distribution first across hours of the day, and then across days of the week. The user behavior and preference analyzer 301 plays a significant role in guiding the FUNC recommendation.

When analyzing an app category type, the user preference analysis targets to characterize the user's long-term mobile device usage history based on various scenarios and associated context background. Typically, in a cluster algorithm, a FUNC can be labeled as a vector <Xᵢ>, where Xᵢ belongs to an infinite list like {0, 1, . . . , G} when representing a business/toolkit category type, such as travel, finance, social type function.

The user behavior and preference analyzer 301 may represent the user preference using a mixture of K Gaussian distributions (K=1 for the case Xᵢ is a binary value), where each Gaussian is weighted according to the frequency with which it belongs to the specific category. Thus, the probability that the user prefers Xₜ at time t may be estimated as:

$$P ( {X}_{t} ) = {\sum }_{i = 1}^{K} {w}_{i , t} \frac{1}{\sqrt{2 π} {σ}_{i}} {e}^{- \frac{1}{2} {( {X}_{t} - {μ}_{i , t} )}^{T} {\sum }^{- 1} ( {X}_{t} - {μ}_{i , t} )} , \qquad ( 1 )$$

where t represents time information; K represents the number of categories related to the current mobile app; w_{i,t} is a normalized weight; and μᵢ and σᵢ are the mean and the standard deviation of the i-th distribution, respectively.

The most influential distribution in the mixture form needs to be determined and may be used to determine whether the current user has a specific preference or not. Heuristically, the Gaussian distributions with the most supporting evidence and the least variance may indicate the likeliness of the distribution. The user behavior and preference analyzer 301 may sort the K distributions based on the value of W/σ and maintain an ordered list. Thus, the most likely distributions may be kept on top and the less probable state-transient distributions may be kept at the bottom.

The most likely distribution models for a FUNC category may be obtained by:

B=arg min_{b}(Σⱼ₌₁^{b}wⱼ>T), (2)

where the threshold T is the fraction of the total weight given to a specific category.

The user behavior and preference analyzer 301 may check the current user in evaluation against the existing K Gaussian distributions to detect whether a distance between the mean of a distribution and the current preference value is within a predetermined range of the standard deviation of this distribution (e.g., 2.5 times of the standard deviation of this distribution). If none of the K distributions succeeds in the evaluation, the least probable distribution which has the smallest value of w/σ is replaced by a new Gaussian distribution with the current value as its mean, and a pre-assigned high variance and low prior weight. Otherwise, if the matched distribution is one of the B distributions, the user preference is marked.

The user behavior and preference analyzer 301 may keep this model adaptive and continuously update the model parameters using the next app selection from the same user. For the matched Gaussian distribution, all the parameters at time t are updated with this new value Xₜ. In addition, the prior weight is updated by:

wₜ=−(1α)+wₜ₋₁α, (3)

and the mean and variance are updated by:

μₜ=−(1ρ)+μₜ₋₁ρXₜ, (4)

and

σₜ²=−(1ρ)+σₜ₋₁²ρ(−Xₜμₜ)², (5)

where α is a learning rate controlling adaptation speed, 1/α defines the time constant which determines change, and ρ is the probability associated with the current user, scaled by the learning rate α. So ρ can be represented by:

$$ρ = α \frac{1}{\sqrt{2 π} {σ}_{t}} {e}^{- \frac{{( {X}_{t} - {μ}_{t} )}^{2}}{{σ}_{t}^{2}}} . \qquad ( 6 )$$

For unmatched distributions, the mean μₜ and variance σₜ remain unchanged, while the prior weight is updated by:

wₜ=(1α)−wₜ₋₁. (7)

Thus, the original preference distribution may remain in the mixture until it becomes the least probable distribution and a new preference is observed. If this static preference happens to change, the previous preference distribution can be rapidly reincorporated into the model.

After the analysis, the user behavior and preference analyzer 301 may output analysis results to other modules or units, such as the FUNC recommender 303, the app pool 306, the next-step FUNC predictor 307, and the longer-term FUNC predictor 308 for further data processing.

The FUNC recommender 303 may be configured to make initial FUNC recommendation to the user based on the current state of the mobile device and the user's past interaction history. The initial FUNC recommendation may be determined or selected by the FUNC recommender 303 to be available for recommendation.

The current scenario detector 305 may be configured to determine the main page for the current scenario utilizing the sensing capability of the mobile device. For example, the scenario can be at home, at work, ready to dine, on the car, and so on. The sensors include location/position sensors, connection/interaction sensors, motion/touch sensors, media sensors, and software sensors, and so on. If the user can cooperate to label some activities, the system can learn and recognize the activities or scenarios later.

The next-step FUNC predictor 307 may be configured to predict which FUNC the user wants to enter at the next step. That is, the next-step FUNC predictor 307 may automatically predict the next function that the user may need all the time. For example, a user can activate the next-step FUNC floating window anytime, on which multiple recommended FUNCs are listed for the user. If the next-step FUNC predictor 307 fails to capture the user's immediate need, the user may have to go to the system home page (or the mobile app page) to find the mobile app to achieve the goal. From this point of view, the accuracy of the next-step FUNC predictor 307 is desired.

The longer-term FUNC predictor 308 may be configured to predict the user's potential FUNC usage in the next day or after a certain period of time. The prediction helps the FUNC controller to shuffle the mobile apps between the cloud and the endpoint.

The FUNC controller 309 may be configured to move the mobile apps between the cloud and the endpoint storage to make sure that the FUNCs to be used are available. A dynamic app shuffling mechanism is provided to automatically shuffle the apps on the mobile device and on the cloud according to the guidance of the longer-time FUNC predictor, in order to meet the user's immediate needs. That is, the dynamic app shuffling mechanism is provided to balance between device storage limitation and immediate access of the FUNCs that the user wants to enter.

Specifically, the FUNC controller 309 may dynamically determine whether to install a native app (associated with a FUNC) from the cloud to local or uninstall a local native app by the dynamic app shuffling mechanism. In addition, the FUNC controller 309 determines the presence of the FUNC associated mobile app in local. Therefore, the FUNC controller 309 may keep the predicted FUNCs by highest prediction scores or likeliness locally.

The endpoint 31 (e.g., mobile device 102) may include a FUNC usage module 311, a user interface (UI) and user interaction module 313, and a virtual app pool 315.

The UI and user interaction module 313 may be configured to receive a user input associated with using mobile apps from a user, the FUNCs recommended from the FUNC recommender 303 in the cloud platform as well as the next-step FUNCs recommended from the next-step FUNC predictor 307 in the cloud platform. The UI and user interaction module 313 may receive the user's input via an input device or the user's finger(s). After receiving the user's input, the UI and user interaction module 313 may perform certain input processing, such as selecting an app to run or removing an app from the interface, etc. Further, the UI and user interaction module 313 may determine whether the user's input changes any of the current recommendation settings.

The FUNC usage module 311 may be configured to send behavior statistics data of the user of the mobile device to the cloud platform. The behavior statistics data of the user of the mobile device may include the distribution of user accesses over time, the number of touches on certain icon (or button) or gestures on the mobile device, and so on.

The virtual app pool 315 is used to swap the mobile apps between the local mobile device and the cloud virtual app pool 306 because the mobile device cannot install all mobile apps on the mobile device due to storage limitation.

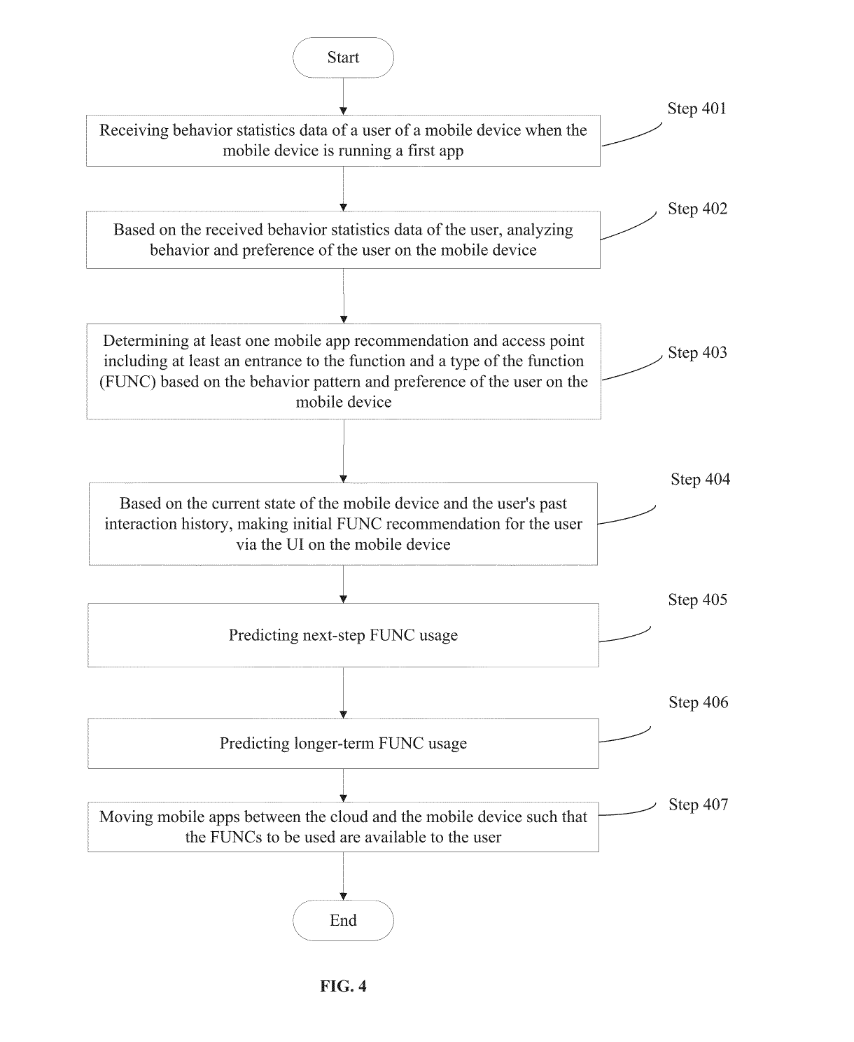

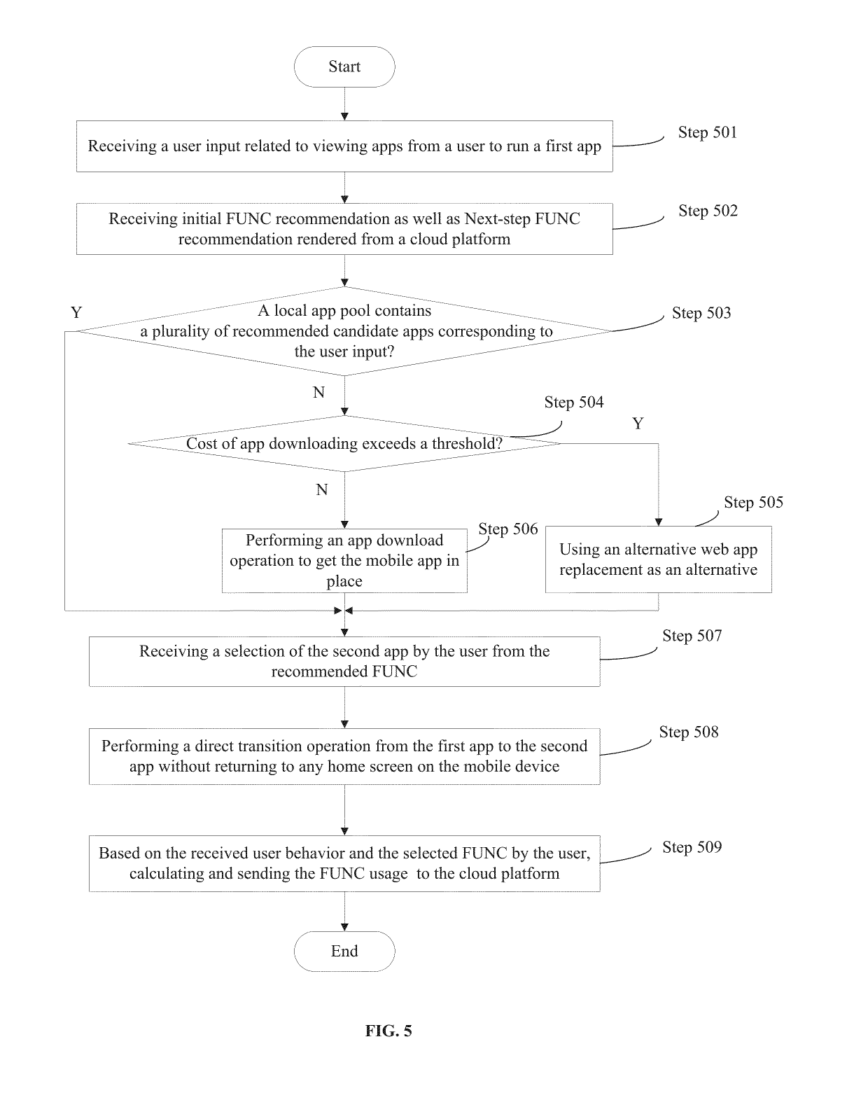

Thus, in operation, the system may perform certain processes for direct transition between two mobile app pages. FIG. 4 shows an exemplary process for direct app transition performed by a cloud platform consistent with the disclosed embodiments. As shown in FIG. 4, from a cloud platform side, the direct transition process may include the following steps.

The cloud platform receives behavior statistics data of a user of a mobile device when the mobile device is running a first app (Step 401). Then, based on the received behavior statistics data of the user, behavior and preference of the user on the mobile device are analyzed (Step 402). The cloud platform closely monitors the user's interactions with the mobile device and analyzes a FUNC flow pattern of the user's mobile device usage based on the received behavior statistics data of the user.

Specifically, when analyzing an app category type, the user preference analysis targets to characterize the user's long-term mobile device usage history based on various scenarios and associated context background. Typically, a FUNC can be labeled as a vector <Xᵢ>, where Xᵢ belongs to an infinite list like {0, 1, . . . , G} when representing a business/toolkit category type, such as travel, finance, social type function.

The cloud platform may represent the user preference using a mixture of K Gaussian distributions (K=1 for the case Xᵢ is a binary value), where each Gaussian is weighted according to the frequency with which it belongs to the specific category. Thus, the probability that the user prefers Xₜ at time t may be estimated by Formula (1).

The most influential distribution in the mixture form needs to be determined and may be used to determine whether the current user has a specific preference or not. Heuristically, the Gaussian distributions with the most supporting evidence and the least variance may indicate the likeliness of the distribution. The cloud platform may sort the K distributions based on the value of w/σ and maintain an ordered list. Thus, the most likely distributions may be kept on top and the less probable state-transient distributions may be at the bottom.

The cloud platform may check the current user in evaluation against the existing K Gaussian distributions to detect whether a distance between the mean of a distribution and the current preference value is within a predetermined range of the standard deviation of this distribution (e.g., 2.5 times of the standard deviation of this distribution). If none of the K distributions succeeds in the evaluation, the least probable distribution which has the smallest value of w/σ is replaced by a new Gaussian distribution with the current value as its mean, and a pre-assigned high variance and low prior weight. Otherwise, if the matched distribution is one of the B distributions, the user preference is marked.

The cloud platform may keep this model adaptive and continuously update the model parameters (i.e., prior weight, the mean and variance) using the next app selection from the same user. For the matched Gaussian distribution, all the parameters at time t are updated with this new value Xₜ. For unmatched distributions, the mean μt and variance σt remain unchanged, while the prior weight is updated by Formula (7).

In this updating method, the original preference distribution remains in the mixture until the preference distribution becomes the least probable distribution and a new preference is observed. Therefore, if this static preference happens to change, the previous preference distribution is rapidly reincorporated into the model.

Based on the user behavior pattern and preference of the user on the mobile device, at least one mobile app recommendation and access point including at least an entrance to the function and a type of the function (FUNC) are determined, where the at least one FUNC includes at least a second app different from the first app (Step 403).

Then, based on the current state of the mobile device and the user's past interaction history, the cloud platform makes initial FUNC recommendation to the user via the UI on the mobile device (Step 404).

Further, the cloud platform predicts next-step FUNC usage (i.e., the FUNC that the user may enter at the next step) (Step 405). For example, a user can activate the next-step FUNC floating window anytime, on which multiple recommended FUNCs are listed for the user. If the user's immediate need is not captured, the user may go to the system home page (or the mobile app page) to find the mobile app to achieve the goal.

Further, the cloud platform may also predict longer-term FUNC usage (Step 406). That is, the user's potential FUNC usage in the next day or after a certain period of time may be predicted by the cloud platform. The prediction in the next day or after the certain period of time helps the user to shuffle the mobile apps between the cloud and the endpoint sides.

Both the next-step FUNC prediction and the longer-term FUNC prediction can be done following a user preference model. Within the preferred category, the mobile device can choose the FUNCs (or associated apps) that are already installed locally as higher priority choices. Therefore, based on user behavior and preference study, the app page prediction mechanism can move a user's mobile device from one app page to another app page by predicting his/her intention.

Based on results of both the next-step FUNC prediction and the longer-term FUNC prediction, the mobile apps are moved between the cloud and the mobile device storage by using a dynamic app shuffling mechanism such that the FUNCs to be used are available to the user (Step 407). Thus, the predicted FUNCs by highest prediction scores or likeliness are kept locally.

The dynamic app shuffling mechanism may dynamically determine whether to install a native app (associated with a FUNC) from the cloud platform to local (i.e., the mobile device), or uninstall a local native app. However, due to the randomness of a user's needs, the FUNCs to be prepared to satisfy the user can include various apps (e.g., native apps or web apps). Although the current mobile devices have bigger and bigger storage space (e.g., 32G or even 128G), the storage limitation for the mobile apps is still there (for example, people may allocate 5G for mobile apps and more space for mobile app contents) as the current native mobile app size also grows (10M mobile app is very common), thus only limited number of apps can be installed locally. In another word, if a native mobile app has not been installed locally but it is triggered by a FUNC that the user decides to use right away, then an immediate app downloading and installation is trigged (the process typically takes 10 seconds or even more depending on the network condition as well as the size of the downloaded mobile app), which impacts the response time of the user request, and brings down the user experiences if this scenario occurs often. Therefore, the FUNC controller optimizes the user experiences by balancing between the storage limitation and response time. The FUNC provides an entrance to a native app, a web app or a customized function. Table 1 shows 6 options (access point) that enable the FUNC to be handled in a dynamic manner.

TABLE 1

| No. | Access point | Response time | Local storage |
|---|---|---|---|
| 1 | a link or shortcut to an installed | fast | the same as the app size |
| | native app page | | |
| 2 | a link to a web app page | a little slower | no |
| | | than an installed | |
| | | native app page | |
| 3 | a link to a customized function | fast | some |
| 4 | a link to a page of a compressed | slow | smaller than the app size |
| | version of a native app | | |
| 5 | a link to the action of native app | very slow | no local storage allocation |
| | downloading and installation | | is required before the link |
| | | | is triggered |
| 6 | a link to an app guideline page that | slower than a | some |
| | suggests a user to open an | web app page | |
| | alternative app | | |

As shown in Table 1, when the access point is a link or shortcut to a page of an installed native mobile app, the response time is fast, and the storage allocation is required for the app. Thus, the native mobile app may provide fast performance and a high degree of reliability.

When the access point is a link to a customized function on a mobile device based on a cloud API service (if the customized function is available), the response time is fast, and some local storage allocation is involved.

When the access point is a link to a web app page (if the web app page is available), the response time is a little slower than a native app page, and no local storage is allocated.

When the access point is a link to a page of the compressed version of a native app, the response time is slow considering the uncompressing time for the app, and the storage allocation request is smaller than the app size. Various compression methods may be available for such solutions.

When the access point is a link to an action of native app downloading and installation, the response time is substantially slow, although no local storage allocation is required before the link is triggered.

When the access point is a link to an app guideline page that suggests the user to open an alternative app targeting for a similar (not same) FUNC that does not require downloading and installation, the response time is slower than the web app page as more user interactions are needed, but the user experience can be compromised.

Returning to FIG. 4, in Step 407, the dynamic app shuffling mechanism can be formalized into an optimization process. Let denote by S the total local storage limitation for the mobile apps, {Fₘ} (m belongs to {1, 2, . . . , M}) the set of mobile apps associated with the FUNCs recommended by the Longer-Term FUNC prediction, N the number of types of local presence of FUNC, and {s_{m,n}, r_{m,n}} (n belongs to {1, 2, . . . , N}) the corresponding storage allocation and request time for each presence of the function in {Fₘ}. The problem can be formalized by:

$${Min}_{n} {\sum }_{m = 1}^{M} {r}_{m , n} , \\ such that \\ {\sum }_{m = 1}^{M} {s}_{m , n} \leq S . \qquad ( 8 )$$

It should be noted that the additional storage for the occasions that some apps need to be downloaded immediately is not considered as such occurrences should be controlled to minimum in order to achieve reasonable user experiences, thus the additional storage can be negligible.

The Formula (8) can be resolved with a Lagrange multiplier method to relax the storage constraint, and the relaxed problem can be solved using a shortest path algorithm in graph theory. Let U be the set of all possible decision vectors u_{m,n} for the item, where u_{m,n}={s_{m,n}, r_{m,n}}, then a Lagrangian cost function can be defined by:

$${J}_{λ} ( u ) = {\sum }_{m = 1}^{M} ( {r}_{m , n} + λ * {s}_{m , n} ) , \qquad ( 9 )$$

where λ is a Lagrange multiplier.

If there exists a λ* such that u*=arg [minᵤ J_{λ}(μ)] leads to the condition that total storage of u* equals to S, then u* is also an optimal solution to Formula (9). Therefore, the task of solving Formula (9) is equivalent to an easier task of finding the optimal solution to the unconstrained problem that minimizes the cost function J_{λ}(u) and choosing the appropriate Lagrange multiplier to satisfy the constraint. The problem can be converted into a graph theory problem of finding the shortest path in a directed acyclic graph (DAG) that can be easily solved.

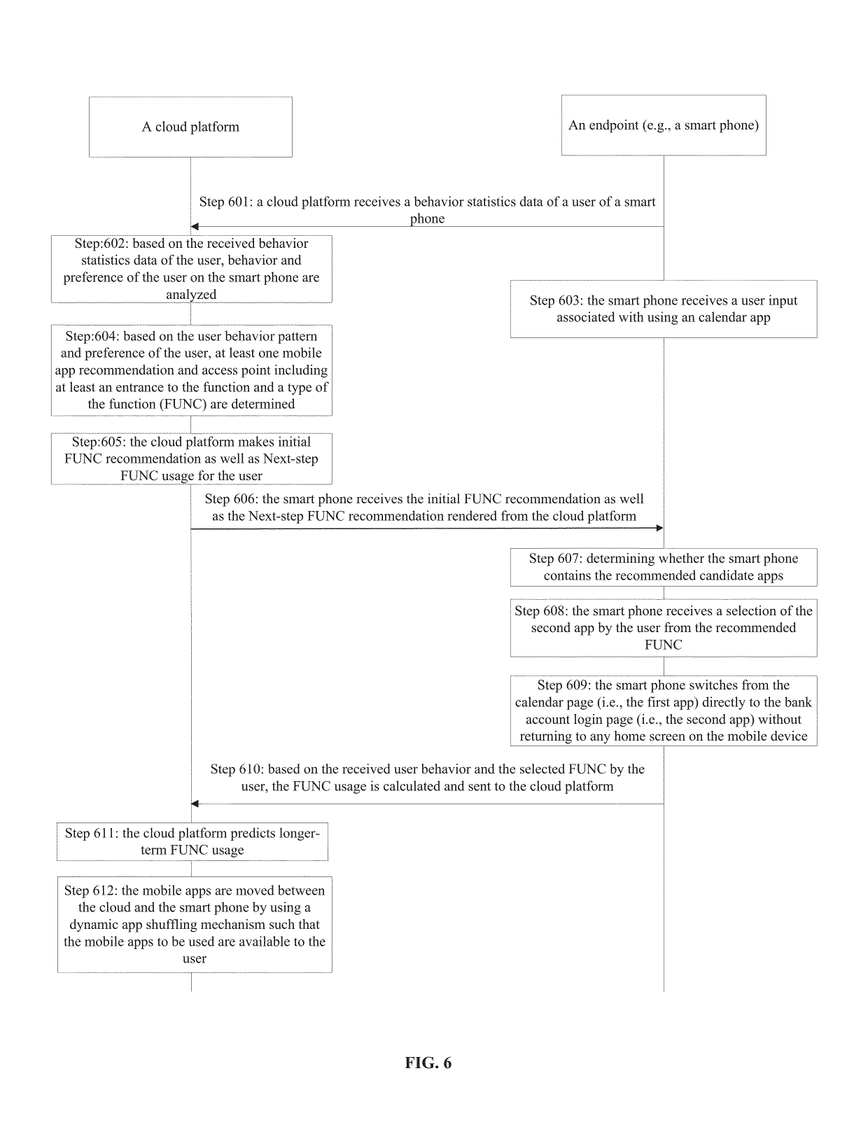

FIG. 5 shows an exemplary process for direct app transition performed by a mobile device consistent with the disclosed embodiments. As shown in FIG. 5, from the mobile device side, the direct transition process may include the following steps.

At the beginning, the mobile device receives a user input associated with using mobile apps from a user to run a first app (Step 501). The user input operation can be performed by an input device or the user's finger(s). The input device may include any simple input/output device, such as a keyboard, a mouse, a Touch Pen Stylus and a voice-activated input device, etc.

The mobile device receives initial FUNC recommendation as well as next-step FUNC recommendation rendered from a cloud platform (Step 502). In Step 502, multiple recommended FUNCs for the user to select are listed on the screen of the mobile device. The number of recommended FUNCs may be preset by the user.

Then, the mobile device determines whether a local app pool contains a plurality of recommended candidate apps corresponding to the user input (Step 503). If the local app pool does not contain one or more of the plurality of recommended candidate apps corresponding to the user input (i.e., the recommended candidate mobile apps have not been installed in local), the process goes to Step 504; otherwise, the process goes to Step 507.

In Step 504, the mobile device further determines whether cost of app downloading exceeds a threshold set by the user. If the cost of app downloading exceeds the threshold set by the user (S504, Yes), then an alternative web app replacement is used as an alternative (Step 505) and then the process goes to Step 507. On the other hand, if the cost of app downloading does not exceed the threshold set by the user (S504, No), an app download operation is performed to obtain the mobile app in place (Step 506). The cost may be the time period for downloading the app or amount of money for purchasing and downloading the app. After the corresponding mobile apps are downloaded from an app pool in the cloud platform, the process goes to Step 507.

The mobile device receives a selection of a second app by the user from the recommended FUNC (Step 507). Further, based on the received selection of the second app by the user, a direct transition operation from the first app to the second app is performed without returning to any home screen on the mobile device (Step 508). Based on the received user behavior and the FUNC selected by the user, the FUNC usage is calculated and sent to the cloud platform (Step 509).

FIG. 6 shows another exemplary process for direct transition between two mobile app pages consistent with the disclosed embodiments. As shown in FIG. 6, a smart phone is used as an endpoint, and the direct transition process may include the following steps.

At the beginning, a cloud platform receives behavior statistics data of a user of a smart phone (Step 601). Then, based on the received behavior statistics data of the user, behavior and preference of the user on the smart phone are analyzed (Step 602). The cloud platform closely monitors the user's interactions with the smart phone and analyzes a FUNC flow pattern of the user's smart phone usage based on the received behavior statistics data of the user.

At this time, the user touches, for example, a calendar app (i.e., a first app) on the screen of the smart phone to look at his/her calendar. That is, the smart phone receives a user input associated with using the calendar app (Step 603). Based on the user behavior pattern and preference of the user on the mobile device, at least one mobile app recommendation and access point including at least an entrance to the function and a type of the function (FUNC) are determined, where the at least one FUNC includes at least a second app different from the calendar app (Step 604). The cloud platform makes initial FUNC recommendation as well as next-step FUNC recommendation to the user (Step 605). That is, the cloud platform recommends at least one FUNC to the user.

The smart phone receives the initial FUNC recommendation as well as the next-step FUNC recommendation rendered from the cloud platform (Step 606). Specifically, multiple recommended FUNCs for user selection are listed in a small window on the top of the screen of the smart phone. For example, the list may include email page, contacts page, bank account login page, weather information page, medical dictionary page, and so on. The number of recommended FUNCs may be preset by the user.

Moreover, whether the smart phone contains the recommended candidate apps corresponding to the user input is determined (Step 607). Specifically, if the smart phone does not contain one or more of the recommended candidate apps corresponding to the user input (that is, one or more recommended candidate apps (e.g., medical dictionary) have not been installed on the smart phone), then whether cost of app (e.g., medical dictionary) downloading is exceeds a threshold set by the user is determined. The cost may be the time period for downloading the app or amount of money for purchasing and downloading the app. Further, if the cost exceeds the threshold set by the user, an alternative web app (web dictionary) replacement is used as an alternative; otherwise, the mobile app (e.g., medical dictionary) is downloaded from an app pool in the cloud platform.

Further, the smart phone receives a selection of the second app by the user from the recommended FUNC (Step 608). When the user selects a bank account login page (i.e., a second app page) from the list of recommended candidate apps, the smart phone switches from the calendar page (i.e., a first app page) directly to the bank account login page without returning to any home screen on the mobile device (Step 609). Based on the received user behavior and the FUNC selected by the user, the FUNC usage is calculated and sent to the cloud platform (Step 610).

Moreover, the cloud platform predicts longer-term FUNC usage (Step 611). That is, the user's potential FUNC usage in the next day or after a certain period of time may be predicted by the cloud platform. Based on results of both the next-step FUNC prediction and the longer-term FUNC prediction, the mobile apps are moved between the cloud and the smart phone by using a dynamic app shuffling mechanism such that the apps to be used are available to the user (Step 612).

By using the disclosed methods and systems, a mobile user experience problem is mapped into an optimization problem subject to minimize the total quantity of user interaction and/or the touches on the mobile device. A FUNC presence selection mechanism is used to enable the system to balance between the storage limitation and the response time by determining the presence of FUNC being selected to pre-load on the mobile device. It is understood that the disclosed methods and systems are also not limited to usage scenario for the mobile apps. The disclosed methods may fit into any networked device group in the network to balance between storage limitation and response time of application programs.

Although the method is disclosed for illustrative purposes, similar concept and approach can be applied to all scenarios that have multiple connected devices involved. Other applications, advantages, alternations, modifications, or equivalents to the disclosed embodiments are obvious to those skilled in the art.

What is claimed is:

1. A method for direct app transition on a mobile device, comprising:
receiving behavior statistics data of a user of the mobile device when the mobile device is running a first app;
based on the received behavior statistics data of the user, analyzing behavior pattern and preference of the user on the mobile device;
determining at least one mobile app recommendation and access point including at least an entrance to a function and a type of the function (FUNC) based on the behavior pattern and preference of the user on the mobile device, wherein the at least one FUNC includes at least a second app different from the first app;
recommending the at least one FUNC to the user;
receiving a selection of the second app by the user from the recommended FUNC; and
directly transitioning from a first app page to a second app page without returning to any home screen on the mobile device.

2. The method according to claim 1, wherein:
the type of the function includes at least one of a native app, a web app, and a customized function.

3. The method according to claim 1, wherein:
the access point includes at least one of a link to a web app page, a link to a customized function, a link to an installed native app page, a link to a page of a compressed version of a native app, a link to an action of native app download and installation, and a link to an app guideline page that suggests the user to open an alternative app.

4. The method according to claim 1, wherein recommending at least one FUNC to the user further includes:
based on analyzed results and a current scenario of the mobile device, making an initial FUNC recommendation on the mobile device to the user; and
based on the analyzed results and the current scenario of the mobile device, predicting a next-step FUNC on the mobile device to the user.

5. The method according to claim 1, further including:
based on the analyzed results, performing a longer-term FUNC prediction, wherein the longer-term prediction is potential FUNC usage of the user in a next day and after a certain period of time; and
based on the obtained prediction results, moving the mobile apps between the cloud platform and the mobile device by a dynamic app shuffling mechanism.

6. The method according to claim 1, wherein:
provided that the user preference is represented using a mixture of K Gaussian distributions, a probability that the user prefers Xₜ at time t is estimated as:
$$P ( {X}_{t} ) = {\sum }_{i = 1}^{K} {w}_{i , t} \frac{1}{\sqrt{2 π} {σ}_{i}} {e}^{- \frac{1}{2} {( {X}_{t} - {μ}_{i , t} )}^{T} {\sum }^{- 1} ( {X}_{t} - {μ}_{i , t} )} ,$$
wherein t represents time information; K represents the number of categories related to the current mobile app; w_{i,t} is a normalized weight; and μᵢ and σᵢ are a mean and a standard deviation of an i-th distribution, respectively.

7. The method according to claim 1, wherein:
the dynamic app shuffling mechanism is formalized by:
$${Min}_{n} {\sum }_{m = 1}^{M} {r}_{m , n} , \\ such that$$
$${\sum }_{m = 1}^{M} {s}_{m , n} \leq S .$$
wherein S is total local storage limitation for the mobile apps; M and N are integers greater than 1; m belongs to {1, 2, . . . , M}; n belongs to {1, 2, . . . , N}; and s_{m,n} and r_{m,n} are a corresponding storage allocation and request time, respectively.

8. The method according to claim 1, further including:
determining whether a local app pool contains a plurality of recommended mobile apps corresponding to the user input; and
when the local app pool does not contain one or more of the plurality of recommended mobile apps corresponding to the user input, determining whether cost of app downloading exceeds a threshold set by the user, wherein:
when the cost of the app downloading exceeds the threshold set by the user, a web app replacement as an alternative is used; and
when the cost of the app downloading does not exceed the threshold set by the user, an app download operation to obtain the recommended mobile app in place is performed.

9. A system for direct app transition on a mobile device, comprising:
a user interface and user interaction module configured to receive a user input associated with a first app, and to receive at least one mobile app recommendation and access point including at least an entrance to a function and a type of the function (FUNC) based on behavior pattern and preference of a user on the mobile device, wherein the at least one FUNC includes at least a second app different from the first app;
a local app pool configured to store a plurality of recommended mobile apps locally;
a FUNC usage module configured to send behavior statistics data of the user of the mobile device to a cloud platform;
a user behavior and preference analyzer configured to receive the behavior statistics data of the user of the mobile device when the mobile device is running the first app, and analyze the behavior pattern and preference of the user on the mobile device based on the received behavior statistics data of the user;
a current scenario detector configured to determine a main page for a current scenario utilizing sensing capability of the mobile device;
a FUNC recommender configured to make initial FUNC recommendation to the user based on analyzed results and the current scenario of the mobile device;
a next-step FUNC predictor configured to predict next-step FUNC usage based on the analyzed results and the current scenario of the mobile device;
a longer-term FUNC predictor configured to predict potential FUNC usage of the user in a next day and after a certain period of time; and
a FUNC controller configured to move the mobile apps between the cloud platform and the mobile device by a dynamic app shuffling mechanism such that the FUNCs to be used are available.

10. The system according to claim 9, wherein:
the type of the function includes at least one of a native app, a web app, and a customized function.

11. The system according to claim 9, wherein:
the access point includes at least one of a link to a web app page, a link to a customized function, a link to an installed native app page, a link to a page of a compressed version of a native app, a link to an action of native app download and installation, and a link to an app guideline page that suggests the user to open an alternative app.

12. The system according to claim 9, wherein:
when the local app pool does not contain one or more of the plurality of recommended mobile apps corresponding to the user input, the mobile device determines whether cost of app downloading exceeds a threshold set by the user;
when the cost of the app downloading exceeds the threshold set by the user, the mobile device uses a web app replacement as an alternative; and
when the cost of the app downloading does not exceed the threshold set by the user, the mobile device performs an app download operation to obtain the mobile app in place.

13. The system according to claim 9, wherein:
provided that the user preference is represented using a mixture of K Gaussian distributions, a probability that the user prefers Xₜ at time t is estimated as:
$$P ( {X}_{t} ) = {\sum }_{i = 1}^{K} {w}_{i , t} \frac{1}{\sqrt{2 π} {σ}_{i}} {e}^{- \frac{1}{2} {( {X}_{t} - {μ}_{i , t} )}^{T} {\sum }^{- 1} ( {X}_{t} - {μ}_{i , t} )}$$
wherein t represents time information; K represents the number of categories related to the current mobile app; w_{i,t} is a normalized weight; and μᵢ and σᵢ are a mean and a standard deviation of an i-th distribution, respectively.

14. The system according to claim 9, wherein:
the dynamic app shuffling mechanism is formalized by:
$${Min}_{n} {\sum }_{m = 1}^{M} {r}_{m , n} , \\ such that$$
$${\sum }_{m = 1}^{M} {s}_{m , n} \leq S .$$
wherein S is total local storage limitation for the mobile apps; M and N are integers greater than 1; m belongs to {1, 2, . . . , M}; n belongs to {1, 2, . . . , N}; and s_{m,n} and r_{m,n} are a corresponding storage allocation and request time, respectively.

15. A computer readable storage medium storing computer-executable instructions to execute operations for direct app transition on a mobile device, comprising:
receiving behavior statistics data of a user of the mobile device when the mobile device is running a first app;
based on the received behavior statistics data of the user, analyzing behavior pattern and preference of the user on the mobile device;
determining at least one mobile app recommendation and access point including at least an entrance to a function and a type of the function (FUNC) based on the behavior pattern and preference of the user on the mobile device, wherein the at least one FUNC includes at least a second app different from the first app;
recommending the at least one FUNC to the user;
receiving a selection of the second app by the user from the recommended FUNC; and
directly transitioning from a first app page to a second app page without returning to any home screen on the mobile device.

16. The computer readable storage medium according to claim 15, wherein:
the type of the function includes at least one of a native app, a web app, and a customized function.

17. The computer readable storage medium according to claim 15, wherein:
the access point includes at least one of a link to a web app page, a link to a customized function, a link to an installed native app page, a link to a page of a compressed version of a native app, a link to an action of native app download and installation, and a link to an app guideline page that suggests the user to open an alternative app.

18. The computer readable storage medium according to claim 15, wherein recommending the at least one FUNC to the user further includes:
based on analyzed results and a current scenario of the mobile device, making an initial FUNC recommendation on the mobile device to the user; and
based on the analyzed results and the current scenario of the mobile device, predicting a next-step FUNC on the mobile device to the user.

19. The computer readable storage medium according to claim 15, wherein:
provided that the user preference is represented using a mixture of K Gaussian distributions, a probability that the user prefers Xₜ at time t is estimated as:
$$P ( {X}_{t} ) = {\sum }_{i = 1}^{K} {w}_{i , t} \frac{1}{\sqrt{2 π} {σ}_{i}} {e}^{- \frac{1}{2} {( {X}_{t} - {μ}_{i , t} )}^{T} {\sum }^{- 1} ( {X}_{t} - {μ}_{i , t} )}$$
wherein t represents time information; K represents the number of categories related to the current mobile app; w_{i,t} is a normalized weight; and μᵢ and σᵢ are a mean and a standard deviation of an i-th distribution, respectively.

20. The computer readable storage medium according to claim 15, wherein:
the dynamic app shuffling mechanism is formalized by:
$${Min}_{n} {\sum }_{m = 1}^{M} {r}_{m , n} , \\ such that$$
$${\sum }_{m = 1}^{M} {s}_{m , n} \leq S .$$
wherein S is total local storage limitation for the mobile apps; M and N are integers greater than 1; m belongs to {1, 2, . . . , M}; n belongs to {1, 2, . . . , N}; and s_{m,n} and r_{m,n} are a corresponding storage allocation and request time, respectively.
